(19) United States
(12) Patent Application Publication
(10) Pub. No.: US 2023/0225016 A1
(43) Pub. Date: Jul. 13, 2023

(54) ELECTRICALLY HEATED WINDSHIELD

(71) Applicant: GM GLOBAL TECHNOLOGY OPERATIONS LLC, Detroit, MI (US)

(72) Inventors: Julien P. Mourou, Bloomfield Hills, MI (US); Rachit Garg, Bangalore (IN); Omar Rodrigo Garcia Martinez, Tlalnepantla (MX); Gerard Parij, Warren, MI (US)

(21) Appl. No.: 17/573,751

(22) Filed: Jan. 12, 2022

(51) Int. Cl. H05B 3/86; B60S 1/02

(52) U.S. Cl. CPC H05B 3/86; B60S 1/026; H05B 2203/013

(57) ABSTRACT

An electrically heatable panel may include a conductive coating patterned to have a conductive profile with a narrow region whereby current density is greater in the narrow region thus providing increased heat dissipation in the narrow region.

### INTRODUCTION

This disclosure is related to electrically heated windshields.

Ice, frost, fog, mist and other windshield moisture conditions may occlude an operator’s view through the windshield. Rapid melting and evaporation (i.e., clearing) of water on a windshield allows a vehicle operator to begin a trip with minimal delay due to such conditions.

It is known that warm air may be blown across the interior surface of the windshield through defroster vents to clear the windshield. In vehicles equipped with internal combustion engines, the heat source for the warm air may come from a heater core connected to an engine coolant loop which will not circulate hot coolant through the heater core until the engine reaches a predetermined temperature thereby resulting in heat availability delays. In electric vehicles, the heat source for the warm air may come from a resistive heating element, thereby providing relatively rapid heat availability. Regardless of the heat source, however, such warm air delivery systems work to initially clear smaller regions of the windshield where the heated air primarily impinges and slowly extends the clearing outward from those regions to larger areas of the windshield.

It is known to resistively heat automotive glass, including windshield glass and backlight glass. Conductive inks are commonly used to provide an electrically resistive defroster grid on backlight glass. However, such defroster grids are not suitable for use on windshield glass due to visibility and other factors. Electrically heated windshield systems are known including a conductive coating as an interior layer in a laminated windshield and to pass current through the conductive coating to resistively heat the windshield. However, current and power available from 12 volt automotive accessory power systems limit the effectiveness and utility of such systems.

### SUMMARY

In one exemplary embodiment, an electrically heatable panel may include a first glass sheet, first and second spaced apart bus bars, and an electrically conductive coating adjacent the first glass sheet disposed between the first and second spaced apart bus bars, the electrically conductive coating having a conductive profile with at least one locally narrow region.

In addition to one or more of the features described herein, the electrically heatable panel may further include a second glass sheet wherein the electrically conductive coating is intermediate the first glass sheet and the second glass sheet.

In addition to one or more of the features described herein, the electrically heatable panel the electrically conductive coating may include a single thin film conductive layer.

In addition to one or more of the features described herein, the electrically conductive coating may include multiple thin film conductive layers wherein adjacent ones of the multiple thin film conductive layers are separated by a respective thin film intermediate layer.

In addition to one or more of the features described herein, the electrically heatable panel may further include a thermoplastic sheet intermediate the first glass sheet and the second glass sheet.

In addition to one or more of the features described herein, the electrically heatable panel may include an automobile windshield wherein the at least one locally narrow region is on at least one of a passenger side of the windshield and a driver side of the windshield.

In addition to one or more of the features described herein, the electrically conductive coating may be disposed upon the thermoplastic sheet.

In addition to one or more of the features described herein, the electrically conductive coating may be disposed upon at least one of the first glass sheet and the second glass sheet.

In addition to one or more of the features described herein, the electrically heatable panel may include an automobile windshield and the conductive profile may include a respective locally narrow region on a passenger side of the windshield and a respective locally narrow region on a driver side of the windshield.

In addition to one or more of the features described herein, the respective locally narrow region on the passenger side of the windshield may correspond to a passenger side central region of the windshield and the respective locally narrow region on the driver side of the windshield may correspond to a driver side central region of the windshield.

In another exemplary embodiment, an electrically heatable windshield for a vehicle may include a conductive coating substantially completely covering the windshield, the conductive coating having an effective conduction region and at least one current isolated region, and a first bus bar and a second bus bar ohmically coupled to the effective conduction region.

In addition to one or more of the features described herein, the conductive coating may be located between a first glass sheet and a second glass sheet.

In addition to one or more of the features described herein, the effective conduction region may include a conductive profile with at least one locally narrow region between the first bus bar and the second bus bar.

In addition to one or more of the features described herein, the first bus bar may be located proximate a driver side edge of the windshield, and the second bus bar may be located proximate a passenger side edge of the windshield.

In addition to one or more of the features described herein, the first bus bar may be located proximate an upper edge of the windshield, and the second bus bar may be located proximate a lower edge of the windshield.

In addition to one or more of the features described herein, the conductive profile may include a respective locally narrow region on a passenger side of the windshield and a respective locally narrow region on a driver side of the windshield.

In addition to one or more of the features described herein, the electrically heatable windshield may further include a third bus bar and a fourth bus bar ohmically coupled to the at least one current isolated region.

In addition to one or more of the features described herein, the electrically heatable windshield may further include a third bus bar ohmically coupled to the effective conduction region.

In yet another exemplary embodiment, a method for manufacturing a heated windshield may include coating a windshield sheet substrate with a conductive coating to substantially completely cover the windshield, ohmically coupling the conductive coating between a first bus bar and a second bus bar, and selectively removing the conductive coating along isolation paths to pattern an effective conduction region and current isolated regions, wherein the effective conduction region may include a conductive profile with at least one locally narrow region between the first bus bar and the second bus bar.

In addition to one or more of the features described herein, selectively removing the conductive coating along isolation paths may include ablating the conductive coating along isolation paths.

The above features and advantages, and other features and advantages of the disclosure are readily apparent from the following detailed description when taken in connection with the accompanying drawings.

### BRIEF DES CRIPTION OF THE DRAWINGS

Other features, advantages, and details appear, by way of example only, in the following detailed description, the detailed description referring to the drawings in which:

FIG. 1 schematically illustrates an embodiment of an electrically heated panel, in accordance with the present disclosure;

FIG. 2A schematically illustrates a partial sectional view of an embodiment through line A-A of FIG. 1, in accordance with the present disclosure;

FIG. 2B schematically illustrates a partial sectional view of an embodiment through line A-A of FIG. 1, in accordance with the present disclosure;

FIG. 3 illustrates an embodiment of an electrically heated panel, in accordance with the present disclosure;

FIG. 4 illustrates an embodiment of an electrically heated panel, in accordance with the present disclosure;

FIG. 5 illustrates an embodiment of an electrically heated panel, in accordance with the present disclosure;

FIG. 6 illustrates an embodiment of an electrically heated panel, in accordance with the present disclosure;

FIG. 7 illustrates an embodiment of an electrically heated panel, in accordance with the present disclosure;

FIG. 8 illustrates an embodiment of an electrically heated panel, in accordance with the present disclosure;

FIG. 9 illustrates an embodiment of an electrically heated panel, in accordance with the present disclosure;

FIG. 10 illustrates an embodiment of an electrically heated panel, in accordance with the present disclosure; and

FIG. 11 illustrates an embodiment of an electrically heated panel, in accordance with the present disclosure.

### DETAILED DESCRIPTION

The following description is merely exemplary in nature and is not intended to limit the present disclosure, its application or uses. Throughout the drawings, corresponding reference numerals indicate like or corresponding parts and features.

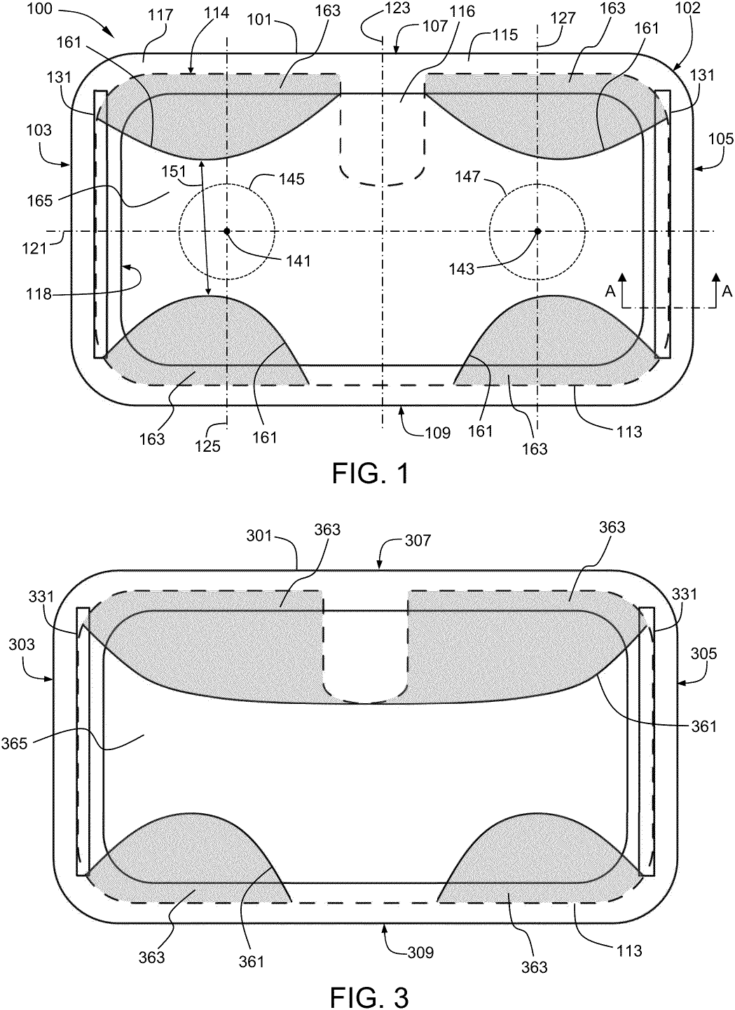

The various figures are schematic representations, and no significance is intended by or to be attributed to the absolute or relative scaling of the various features illustrated therein. Like reference numbers refer to the same or like components in the several figures. FIG. 1 schematically illustrates an electrically heatable panel 100 embodied in a windshield 101 for a motor vehicle. The windshield 101 may be defined by a perimeter edge 102 including an upper edge 107, a lower edge 109, driver side edge 103 and passenger side edge 105. The windshield 100 may include a horizontal centerline 121 substantially midway between the upper edge 107 and the lower edge 109, and a vertical centerline 123 substantially midway between the driver side edge 103 and the passenger side edge 105. Driver side as used herein refers to the region of the windshield 101 to the side of the vertical centerline 123 where a driver may be seated. Similarly, passenger side as used herein refers to the region of the windshield 101 to the side of the vertical centerline 123 where a front seat passenger may be seated. The windshield 101 may further be defined relative to a driver side central vertical axis 125 substantially midway between the driver side edge 103 and the vertical centerline 123 of the windshield 101. Likewise, the windshield 101 may further be defined relative to a passenger side central vertical axis 127 substantially midway between the passenger side edge 105 and the vertical centerline 123 of the windshield 101. The driver side central vertical axis 125 intersects the horizontal centerline 121 at point 141 and the passenger side central vertical axis 127 intersects the horizontal centerline 121 at point 143.

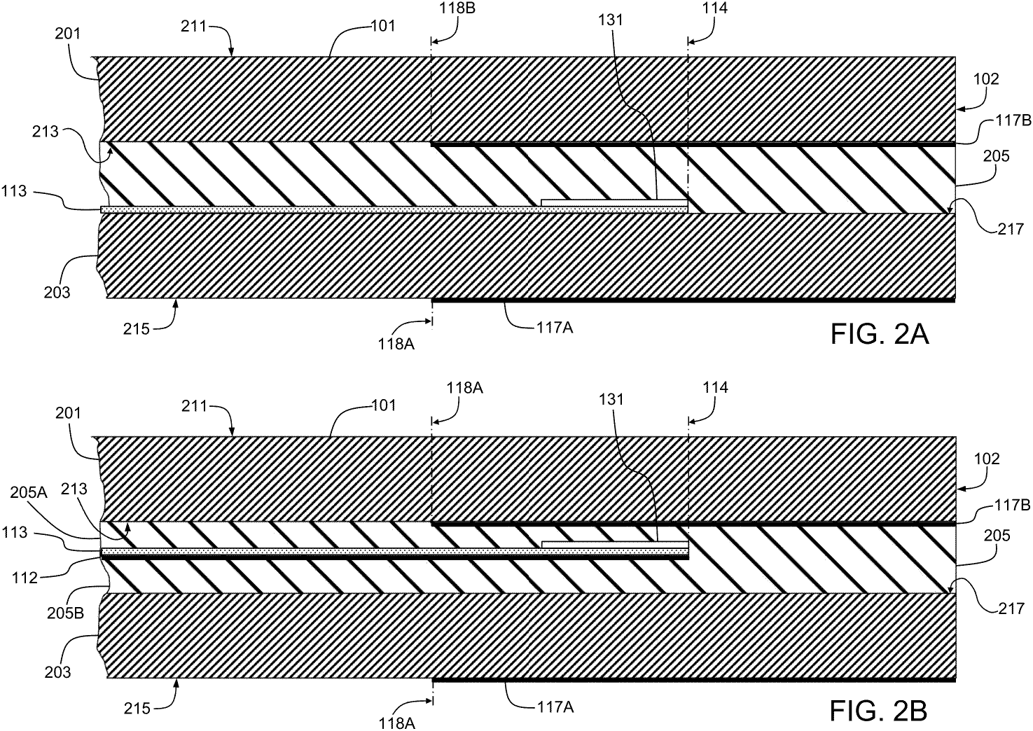

With additional reference to the partial sectional view of the windshield 100 in FIG. 2A taken through line A-A of FIG. 1, the windshield 101 may include a first glass sheet 201 and a second glass sheet 203. The first glass sheet 201 and the second glass sheet 203 may be bonded to each other via an intermediate thermoplastic sheet 205, for example poly-vinyl butyral (PVB). The first glass sheet 201 includes an outer surface 211 and an inner surface 213. The second glass sheet 203 includes an outer surface 215 and an inner surface 217. In the present illustration of FIG. 2A, the first glass sheet 201 faces outside of the vehicle whereas the second glass sheet faces inside the vehicle. The perimeter edge 102 of the windshield 101 commonly defines each of the first glass sheet 201 and the second glass sheet 203.

The second glass sheet 203 may be fabricated beginning with an electrically conductive coating 113 disposed over substantially the entire inner surface 217. Known thin film fabrication process may be used to coat the second glass sheet with the electrically conductive coating 113 including, for example, physical vapor deposition (e.g., sputtering) and chemical vapor deposition. Any appropriately conductive material may be used for the electrically conductive coating 113, including silver, to achieve a desired sheet resistance. The electrically conductive coating 113 may be ablated from the inner surface 217 at the extreme limits of the second glass sheet 203 in a region 115 inward from the perimeter edge 102 of the windshield 101 to a film limit edge 114 as shown by the broken line. This may be done to ensure hermetic sealing of the electrically conductive coating 113 around the entire perimeter of the windshield. Laser or other ablation processes may be used. Similarly, other regions of the second glass sheet 203 may have the electrically conductive coating 113 ablated, for example region 116 corresponding to an upper, central region of the windshield 101 which may be used for various radio frequency (RF) communications antenna or other devices whose performance would be materially degraded by such electrically conductive coating. Alternatively, the regions 115 and 116 may be manufactured free from electrically conductive coating 113 by masking. Alternatively, the first glass sheet 201 may be fabricated with the electrically conductive coating 113 disposed thereon. Alternatively, the intermediate thermoplastic sheet 205 may be fabricated with the electrically conductive coating 113 disposed thereon. Any one or more of the glass sheets 201, 203, thermoplastic sheet 205, or other windshield sheet material may provide the necessary sheet substrate for coating with the electrically conductive coating 113. A windshield fabricated with an electrically conductive coating 113 coverage as described, including conductive coating 113 voids at the perimeter or within other designed regions, is considered substantially completely covered by a conductive coating 113. The electrically conductive coating 113 as used herein means one or more thin film conductive layers (e.g., silver) and may include one or more thin film intermediate layers between adjacent thin film conductive layers including, for example, for optical tuning and electrical insulation properties. Thin film intermediate layer means one or more thin film layers between adjacent thin film conductive layers. The second glass sheet 203 may also include a frit band 117A around the perimeter from an inner frit edge 118A to the perimeter edge 102 of the windshield 101. Frit band 117A may be, for example, a black enamel paint and/or ceramic coating applied by using a silk screen printing process or other process. Frit band 117A advantageously hides the bus bars 131 described in further detail below from visibility from within the vehicle and provides a binding surface for windshield adhesive. Alternatively or additionally, the first glass sheet 201 may include a frit band 117B around the perimeter from an inner frit edge 118B to the perimeter edge 102 of the windshield 101. Frit band 117B advantageously hides the bus bars 131 from visibility from outside the vehicle.

FIG. 2B, taken through line A-A of FIG. 1, provides a partial sectional view of the windshield 100 in the windshield 101 in an alternative embodiment wherein the electrically conductive coating 113 is disposed upon a thin carrier sheet layer 112, for example polyethylene terephthalate (PET). The carrier sheet layer 112 and electrically conductive coating may be covered on both sides by thermoplastic sheets 205A and 205B. Other aspects of the embodiment of FIG. 2B are as described in the embodiment of FIG. 2A.

Bus bars 131 are fabricated in ohmic contact with the electrically conductive coating 113. In the embodiment of FIG. 1, the bus bars 131 are proximate the driver side edge 103 and the passenger side edge 105 of the windshield 101. In alternative embodiments, bus bars may be proximate the upper edge 107 and the lower edge 109 of the windshield 101. Bus bars 131 may be fabricated, for example, from a printed silver ceramic paste using a silk screen printing process or other process. Alternatively, bus bars 131 may be a conductive foil, for example copper. The bus bars 131 are ohmically coupled to respective feedlines (not shown) for coupling a DC voltage thereacross. Feedlines may be copper foil soldered to the bus bars.

In one embodiment, the electrically conductive coating 113 is patterned to establish an effective conduction region 165 of the electrically conductive coating 113 that is less than the total area of the electrically conductive coating 113 delimited by the film limit edge 114. Thus, patterning of the electrically conductive coating 113 isolates certain regions of the electrically conductive coating 113 from current conduction between the bus bars 131. Patterning may be accomplished by ablating the electrically conductive coating 113 along a continuous isolation path 161 extending between and through a pair of points on the film limit edge 114. Patterning may alternatively be accomplished by chemical or mechanical etching or any other process effective to remove the electrically conductive coating 113 and ohmically isolate opposite sides of the continuous isolation path 161. Four such continuous isolation paths 161 are illustrated in the embodiment of FIG. 1 corresponding to four current isolated regions 163 (shaded) that are isolated from the effective conduction region 165. Thus, it is appreciated that all current isolated regions 163 are physically separated or discontinuous relative to the effective conduction region 165. The effective conduction region 165 remains ohmically coupled to both bus bars 131 located proximate the driver side edge 103 and the passenger side edge 105 of the windshield 101. Any current isolated region 163 may be ohmically coupled to any one of the bus bars 131 but may not be ohmically coupled to both of the bus bars 131. Thus, when a DC voltage is applied between the two bus bars 131, current flows between the bus bars 131 via the electrically conductive coating 113 within the effective conduction region 165 only, and no current flows via the electrically conductive coating 113 within the current isolated regions 163. Such isolation patterning by removal of electrically conductive coating 113 along a relatively narrow isolation path advantageously maintains the windshield’s aesthetic and heat reflective properties intact since the windshield remains substantially completely covered by the electrically conductive coating 113 and subject to the light transmission and reflective properties thereof.

As used herein, a conductive profile is the substantially two-dimensional surface pattern of the effective conduction region 165 of the electrically conductive coating 113 ohmically coupled between the bus bars 131. In the embodiment of FIG. 1, the conductive profile of the effective conduction region 165 includes a narrow or neck region on the driver side of the windshield 101 between the bus bar 131 located proximate the driver side edge 103 and the vertical centerline 123 of the windshield 101. In the embodiment of FIG. 1, the conductive profile of the effective conduction region 165 also includes a narrow or neck region on the passenger side of the windshield 101 between the bus bar 131 located proximate the passenger side edge 105 and the vertical centerline 123 of the windshield 101. Each such narrow region may have a respective local minimum where the conductive profile is locally most narrow, for example as illustrated by the distance 151 of the narrow region on the driver side. The distance 151 may be referred to herein as a local minimum conductive profile 151. The narrow regions are defined by the conductive profile which diverges in either horizontal direction away from the local minimum. In operation, when a voltage is applied between the bus bars 131, current flows via the electrically conductive coating 113 within the effective conduction region 165. Generally, current density is greatest in the narrow regions and ohmic heating of the electrically conductive coating 113 is likewise greatest in the narrow regions. Thus, these narrow regions of greater current density and heat dissipation may be preferentially located via selective patterning of the effective conduction region 165.

A driver side central region 145 of the windshield 101 as used herein means a region of the windshield within 30 centimeters of the point of intersection of the horizontal centerline 121 of the windshield 101 and the driver side central vertical axis 125 of the windshield. Similarly, a passenger side central region 147 of the windshield 101 as used herein means a region of the windshield within 30 centimeters of the point of intersection of the horizontal centerline 121 of the windshield 101 and the passenger side central vertical axis 127 of the windshield 101. It is appreciated that the driver side central region 145 and the passenger side central region 147 substantially correspond to respective geometrically central regions of the driver and passenger sides of the windshield 101 respectively. In one embodiment, the respective local minimum conductive profiles 151 may intersect the corresponding driver side central region 145 and the passenger side central region 147. As used herein, a locally narrow region is said to correspond to one of the passenger side central region and the driver side central region when the related local minimum conductive profile 151 intersects the respective one of the passenger side central region and the driver side central region.

FIG. 3 illustrates an embodiment of an electrically heated windshield 301 defined by a perimeter edge including an upper edge 307, a lower edge 309, driver side edge 303 and passenger side edge 305. The electrically conductive coating 113 is patterned by isolation paths 361 as described herein. Current isolated regions 363 (shaded) are isolated from the effective conduction region 365. The effective conduction region 365 remains ohmically coupled to both bus bars 331 located proximate the driver side edge 303 and the passenger side edge 305 of the windshield 301. Any current isolated region 363 may be ohmically coupled to any one of the bus bars 331 but may not be ohmically coupled to both bus bars 331. Thus, when a DC voltage is applied between the two bus bars 331, current flows between the bus bars 331 via the electrically conductive coating 113 within the effective conduction region 365 only, and no current flows via the electrically conductive coating 113 within the current isolated regions 363. It is appreciated that the effective conduction region 365 includes narrow regions having local minimums where the conductive profile is locally most narrow. In operation, when a voltage is applied between the bus bars 331, current flows via the electrically conductive coating 113 within the effective conduction region 365 with greater current density and ohmic heating at those narrow regions.

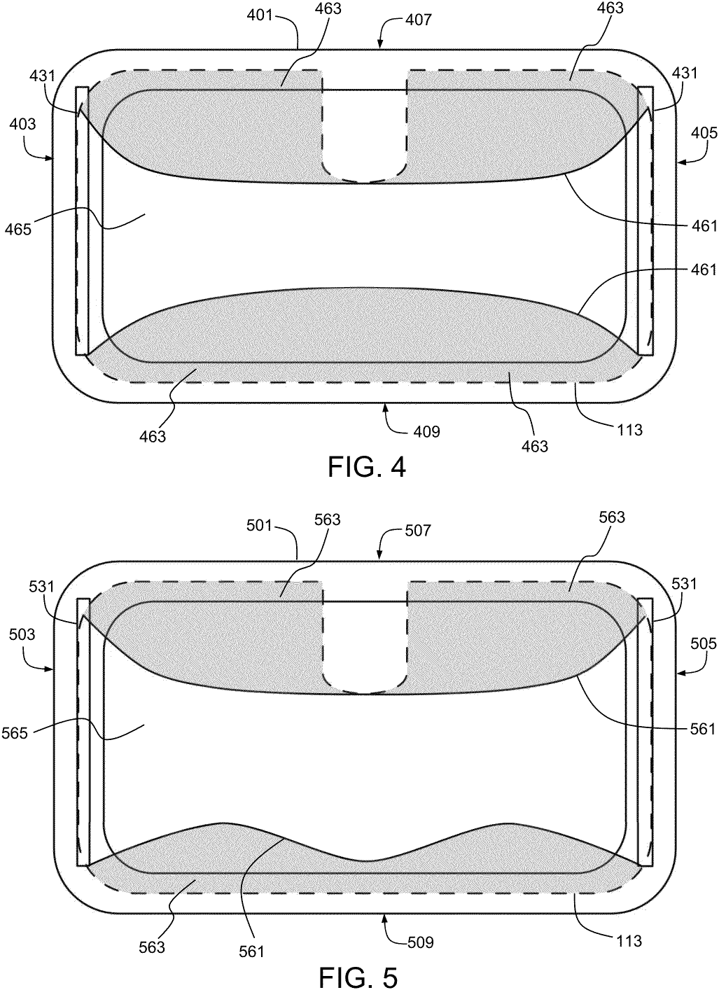

FIG. 4 illustrates an embodiment of an electrically heated windshield 401 defined by a perimeter edge including an upper edge 407, a lower edge 409, driver side edge 403 and passenger side edge 405. The electrically conductive coating 113 is patterned by isolation paths 461 as described herein. Current isolated regions 463 (shaded) are isolated from the effective conduction region 465. The effective conduction region 465 remains ohmically coupled to both bus bars 431 located proximate the driver side edge 403 and the passenger side edge 405 of the windshield 401. Any current isolated region 463 may be ohmically coupled to any one of the bus bars 431 but may not be ohmically coupled to both bus bars 431. Thus, when a DC voltage is applied between the two bus bars 431, current flows between the bus bars 431 via the electrically conductive coating 113 within the effective conduction region 465 only, and no current flows via the electrically conductive coating 113 within the current isolated regions 463. It is appreciated that the effective conduction region 465 includes a narrow region having a local minimum where the conductive profile is locally most narrow. In the present embodiment, the narrow region spans a relatively large horizontal region vertically central in the windshield 401. In operation, when a voltage is applied between the bus bars 431, current flows via the electrically conductive coating 113 within the effective conduction region 465 with greater current density and ohmic heating at the narrow region.

FIG. 5 illustrates an embodiment of an electrically heated windshield 501 defined by a perimeter edge including an upper edge 507, a lower edge 509, driver side edge 503 and passenger side edge 505. The electrically conductive coating 113 is patterned by isolation paths 561 as described herein. Current isolated regions 563 (shaded) are isolated from the effective conduction region 565. The effective conduction region 565 remains ohmically coupled to both bus bars 531 located proximate the driver side edge 503 and the passenger side edge 505 of the windshield 501. Any current isolated region 563 may be ohmically coupled to any one of the bus bars 531 but may not be ohmically coupled to both bus bars 531. Thus, when a DC voltage is applied between the two bus bars 531, current flows between the bus bars 531 via the electrically conductive coating 113 within the effective conduction region 565 only, and no current flows via the electrically conductive coating 113 within the current isolated regions 563. It is appreciated that the effective conduction region 565 includes narrow regions having local minimums where the conductive profile is locally most narrow. In operation, when a voltage is applied between the bus bars 531, current flows via the electrically conductive coating 113 within the effective conduction region 565 with greater current density and ohmic heating at those narrow regions.

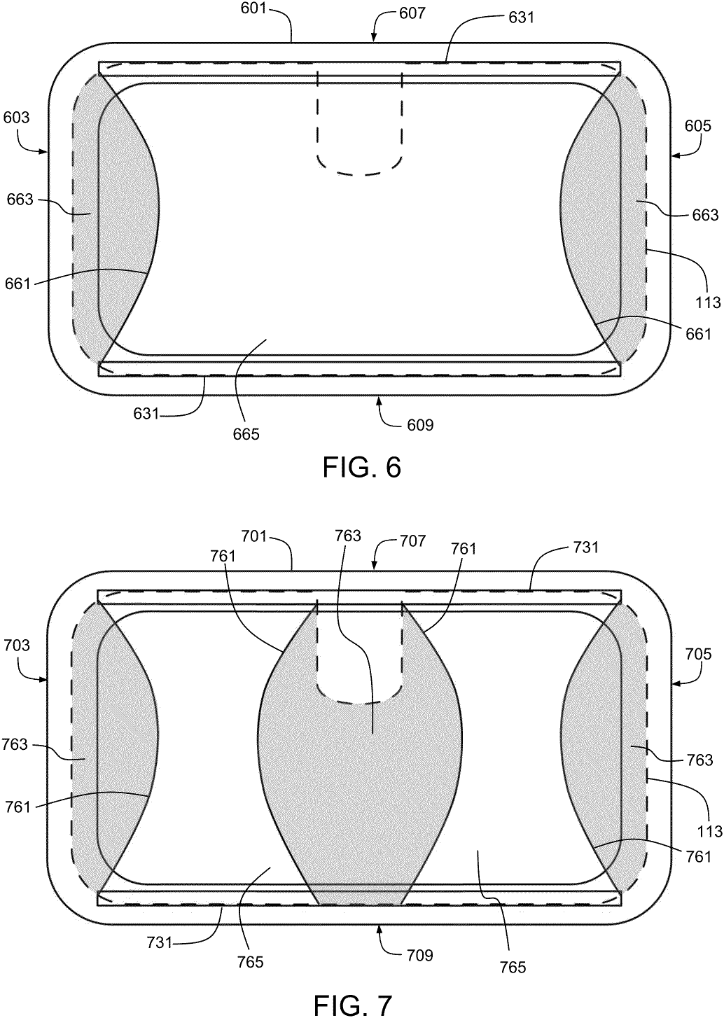

FIG. 6 illustrates an embodiment of an electrically heated windshield 601 defined by a perimeter edge including an upper edge 607, a lower edge 609, driver side edge 603 and passenger side edge 605. The electrically conductive coating 113 is patterned by isolation paths 661 as described herein. Current isolated regions 663 (shaded) are isolated from the effective conduction region 665. The effective conduction region 665 remains ohmically coupled to both bus bars 631 located proximate the upper edge 606 and the lower edge 609 of the windshield 601. Any current isolated region 663 may be ohmically coupled to any one of the bus bars 631 but may not be ohmically coupled to both bus bars 631. Thus, when a DC voltage is applied between the two bus bars 631, current flows between the bus bars 631 via the electrically conductive coating 113 within the effective conduction region 665 only, and no current flows via the electrically conductive coating 113 within the current isolated regions 663. It is appreciated that the effective conduction region 665 includes a narrow region having a local minimum where the conductive profile is locally most narrow. In the present embodiment, the narrow region spans a relatively large vertical region horizontally central in the windshield 601. In operation, when a voltage is applied between the bus bars 631, current flows via the electrically conductive coating 113 within the effective conduction region 665 with greater current density and ohmic heating at the narrow region.

FIG. 7 illustrates an embodiment of an electrically heated windshield 701 defined by a perimeter edge including an upper edge 707, a lower edge 709, driver side edge 703 and passenger side edge 705. The electrically conductive coating 113 is patterned by isolation paths 761 as described herein. Current isolated regions 763 (shaded) are isolated from the effective conduction regions 765. The effective conduction regions 765 remain ohmically coupled to both bus bars 731 located proximate the upper edge 706 and the lower edge 709 of the windshield 701. Any current isolated region 763 may be ohmically coupled to any one of the bus bars 731 but may not be ohmically coupled to both bus bars 731. Thus, when a DC voltage is applied between the two bus bars 731, current flows between the bus bars 731 via the electrically conductive coating 113 within the effective conduction regions 765 only, and no current flows via the electrically conductive coating 113 within the current isolated regions 763. It is appreciated that in the present embodiment there are two effective conduction regions 765, each including a respective narrow region having a local minimum where the conductive profile is locally most narrow. In operation, when a voltage is applied between the bus bars 731, current flows via the electrically conductive coating 113 within the effective conduction regions 765 with greater current density and ohmic heating at the narrow regions.

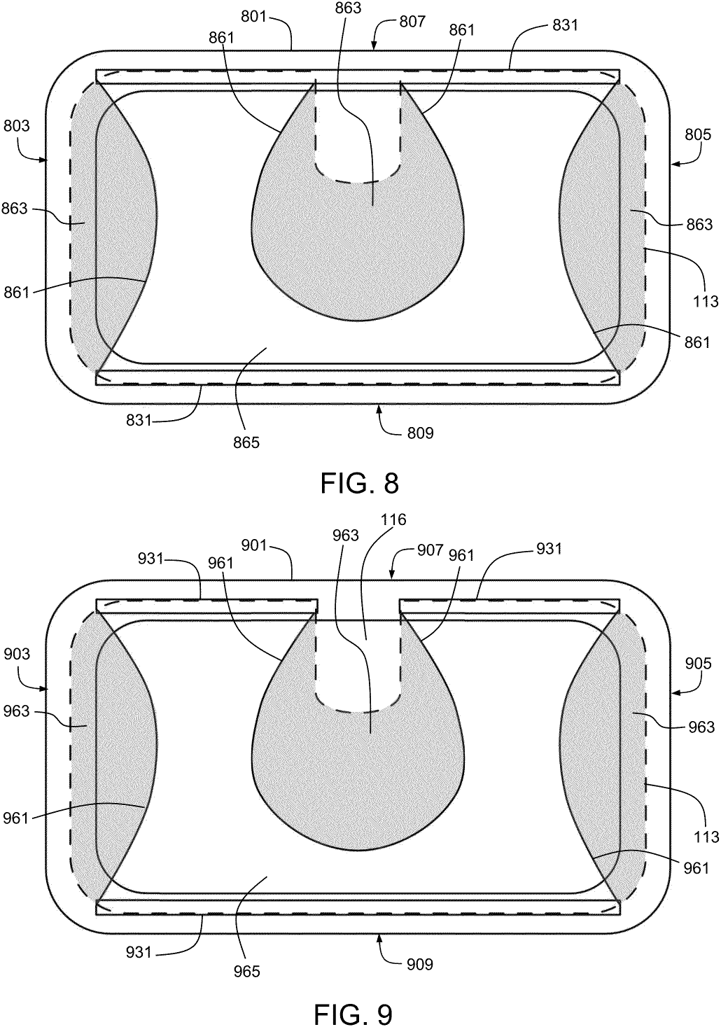

FIG. 8 illustrates an embodiment of an electrically heated windshield 801 defined by a perimeter edge including an upper edge 807, a lower edge 809, driver side edge 803 and passenger side edge 805. The electrically conductive coating 113 is patterned by isolation paths 861 as described herein. Current isolated regions 863 (shaded) are isolated from the effective conduction region 865. The effective conduction region 865 remains ohmically coupled to both bus bars 831 located proximate the upper edge 806 and the lower edge 809 of the windshield 801. Any current isolated region 863 may be ohmically coupled to any one of the bus bars 831 but may not be ohmically coupled to both bus bars 831. Thus, when a DC voltage is applied between the two bus bars 831, current flows between the bus bars 831 via the electrically conductive coating 113 within the effective conduction region 865 only, and no current flows via the electrically conductive coating 113 within the current isolated regions 863. It is appreciated that the effective conduction region 865 includes narrow regions having local minimums where the conductive profile is locally most narrow. In operation, when a voltage is applied between the bus bars 831, current flows via the electrically conductive coating 113 within the effective conduction region 865 with greater current density and ohmic heating at those narrow regions.

FIG. 9 illustrates an embodiment of an electrically heated windshield 901 defined by a perimeter edge including an upper edge 907, a lower edge 909, driver side edge 903 and passenger side edge 905. The electrically conductive coating 113 is patterned by isolation paths 961 as described herein. Current isolated regions 963 (shaded) are isolated from the effective conduction region 965. The effective conduction region 965 remains ohmically coupled to the bus bars 931 located proximate the upper edge 906 and the lower edge 909 of the windshield 901. In the present embodiment, there are two bus bars at the upper edge to either side of region 116 corresponding to an upper, central region of the windshield 901 which may be used for various radio frequency (RF) communications antenna or other devices whose performance would be materially degraded by such electrically conductive coating. Providing bus bars 931 on either side of region 116 may avoid undesirable interference by bus bar currents. Any current isolated region 863 may be ohmically coupled to any one of the bus bars 831 but may not be ohmically coupled to both an upper and a lower bus bar 931. Thus, when a DC voltage is applied between the upper and lower bus bars 931, current flows between the bus bars 931 via the electrically conductive coating 113 within the effective conduction region 965 only, and no current flows via the electrically conductive coating 113 within the current isolated regions 963. It is appreciated that the effective conduction region 965 includes narrow regions having local minimums where the conductive profile is locally most narrow. In operation, when a voltage is applied between the upper and lower bus bars 931, current flows via the electrically conductive coating 113 within the effective conduction region 965 with greater current density and ohmic heating at those narrow regions.

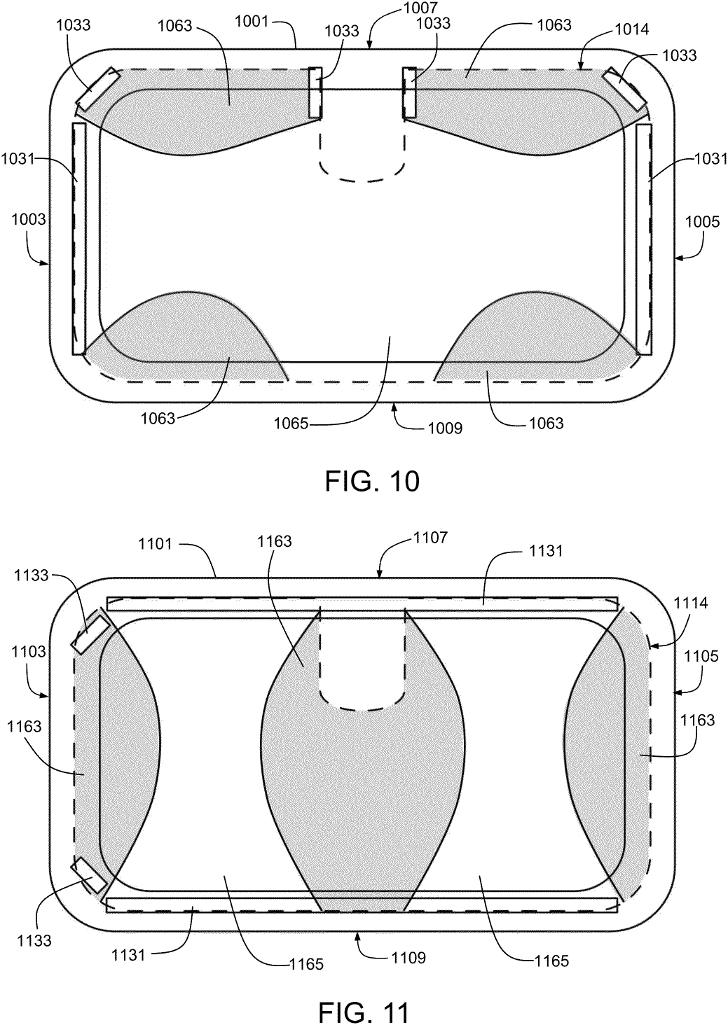

FIG. 10 illustrates an embodiment of a windshield 1001 further adapting isolated regions 1063 located adjacent to the upper edge 1007 for current conduction and heating in those regions. The conductive coating is patterned to establish a first effective conduction region 1065 of the electrically conductive coating that is less than the total area of the electrically conductive coating delimited by the film limit edge 1014. In the embodiment of FIG. 10, one set of bus bars 1031 is proximate the driver side edge 1003 and the passenger side edge 1005 of the windshield 1001 and coupled to the first effective conduction region 1065 substantially as described above in conjunction with FIG. 1. Thus, patterning of the electrically conductive coating isolates the four regions 1063 (shaded) from current conduction between the first set of bus bars 1031. In the present embodiment, each of the regions 1063 adjacent to the upper edge 1007 is coupled to a respective pair of bus bars 1033 and may be referred to herein as second effective conduction regions 1063. Thus, it is appreciated that these second effective conduction regions 1063 are physically separated or discontinuous relative to the first effective conduction region 1065 but adapted for conducting current between corresponding bus bars 1033. Thus, when a DC voltage is applied between the two bus bars 1031, current flows between the bus bars 1031 via the electrically conductive coating within the first effective conduction region 1065. Similarly, when a DC voltage is applied between either or both respective pairs of bus bars 1033, current flows between the respective pairs of bus bars 1033 via the electrically conductive coating within the second effective conduction regions 1063. Each of the first effective conduction region 1065 and the second effective conduction regions 1063 may be selectively controlled into conductive states independently. Thus, the first effective conduction region 1065 may provide primary windshield clearing of the central regions of the driver and passenger sides of the windshield 1001, whereas the second effective conduction regions 1063 may provide secondary clearing above those central regions. Independent selective control advantageously allows for staged clearing of the windshield 1001 whereby each independently controlled region’s power needs may be met by the vehicle’s accessory power system. In operation, the first effective conduction region 1065 may be cleared first and followed by clearing of the second effective conduction regions 1063, though any order of clearing or exclusion of clearing may be invoked. The two regions 1063 adjacent to the lower edge 1009 of the windshield 1001 are illustrated without bus bars but may be adapted in similar fashion for clearing of those regions as described above. Advantageously, such regions 1063 adjacent to the lower edge 1009 may coincide at least partially with parked regions of wiper arms thereby providing melting of ice dams and snow-packs often found in wiper park positions.

FIG. 11 illustrates an embodiment of a windshield 1101 further adapting isolated region 1163 located adjacent to the driver side edge 1103 of the windshield 1101 for current conduction and heating in that region. The conductive coating is patterned to establish first effective conduction regions 1165 of the electrically conductive coating that is less than the total area of the electrically conductive coating delimited by the film limit edge 1114. In the embodiment of FIG. 11, one set of bus bars 1131 is proximate the upper edge 1107 and the lower edge 1109 of the windshield 1001 and coupled to the first effective conduction regions 1165 substantially as described above in conjunction with FIG. 7. Thus, patterning of the electrically conductive coating isolates the three regions 1163 (shaded) from current conduction between the first set of bus bars 1131. In the present embodiment, the region 1163 adjacent to the driver side edge 1103 is coupled to a pair of bus bars 1133 and may be referred to herein as a second effective conduction region 1163. Thus, it is appreciated that this second effective conduction regions 1163 is physically separated or discontinuous relative to the first effective conduction region 1165 but adapted for conducting current between corresponding bus bars 1133. Thus, when a DC voltage is applied between the two bus bars 1131, current flows between the bus bars 1131 via the electrically conductive coating within the first effective conduction regions 1165. Similarly, when a DC voltage is applied between the pair of bus bars 1133, current flows between the pair of bus bars 1133 via the electrically conductive coating within the second effective conduction region 1163. Each of the first effective conduction regions 1165 and the second effective conduction region 1163 may be selectively controlled into conductive states independently. Thus, the first effective conduction regions 1165 may provide primary windshield clearing of the central regions of the driver and passenger sides of the windshield 1101, whereas the second effective conduction region 1163 may provide secondary clearing at the extreme driver side edge 1103 of the windshield 1101. Independent selective control advantageously allows for staged clearing of the windshield 1101 whereby each independently controlled region’s power needs may be met by the vehicle’s accessory power system. In operation, the first effective conduction regions 1165 may be cleared first and followed by clearing of the second effective conduction region 1163, though any order of clearing or exclusion of clearing may be invoked. The region 1163 adjacent to the passenger side edge 1105 of the windshield 1101 is illustrated without bus bars but may be adapted in similar fashion for clearing of that region as described above. Advantageously, the region 1163 adjacent to the driver side edge 1103 may coincide at least partially with the maximum stroke of a wiper arm thereby providing melting of ice dams and snow-packs often found in extreme wiper positions.

All numeric values herein are assumed to be modified by the term “about”, whether or not explicitly indicated. For the purposes of the present disclosure, ranges may be expressed as from “about” one particular value to “about” another particular value. The term “about” generally refers to a range of numeric values that one of skill in the art would consider equivalent to the recited numeric value, having the same function or result, or reasonably within manufacturing tolerances of the recited numeric value generally.

Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electrically heatable panel, comprising:
a first glass sheet;
first and second spaced apart bus bars; and
an electrically conductive coating adjacent the first glass sheet disposed between the first and second spaced apart bus bars, the electrically conductive coating having a conductive profile with at least one locally narrow region.

2. The electrically heatable panel of claim 1, further comprising a second glass sheet wherein the electrically conductive coating is intermediate the first glass sheet and the second glass sheet.

3. The electrically heatable panel of claim 1, wherein the electrically conductive coating comprises a single thin film conductive layer.

4. The electrically heatable panel of claim 1, wherein the electrically conductive coating comprises multiple thin film conductive layers wherein adjacent ones of the multiple thin film conductive layers are separated by a respective thin film intermediate layer.

5. The electrically heatable panel of claim 2, further comprising a thermoplastic sheet intermediate the first glass sheet and the second glass sheet.

6. The electrically heatable panel of claim 1, wherein the electrically heatable panel comprises an automobile windshield and the at least one locally narrow region is on at least one of a passenger side of the windshield and a driver side of the windshield.

7. The electrically heatable panel of claim 5, wherein the electrically conductive coating is disposed upon the thermoplastic sheet.

8. The electrically heatable panel of claim 2, wherein the electrically conductive coating is disposed upon at least one of the first glass sheet and the second glass sheet.

9. The electrically heatable panel of claim 1, wherein the electrically heatable panel comprises an automobile windshield and the conductive profile comprises a respective locally narrow region on a passenger side of the windshield and a respective locally narrow region on a driver side of the windshield.

10. The electrically heatable panel of claim 9, wherein the respective locally narrow region on the passenger side of the windshield corresponds to a passenger side central region of the windshield and the respective locally narrow region on the driver side of the windshield corresponds to a driver side central region of the windshield.

11. An electrically heatable windshield for a vehicle, comprising:
a conductive coating substantially completely covering the windshield;
the conductive coating having an effective conduction region and at least one current isolated region; and,
a first bus bar and a second bus bar ohmically coupled to the effective conduction region.

12. The electrically heatable windshield of claim 11, wherein the conductive coating is located between a first glass sheet and a second glass sheet.

13. The electrically heatable windshield of claim 11, wherein the effective conduction region comprises a conductive profile with at least one locally narrow region between the first bus bar and the second bus bar.

14. The electrically heatable windshield of claim 11, wherein the first bus bar is located proximate a driver side edge of the windshield, and the second bus bar is located proximate a passenger side edge of the windshield.

15. The electrically heatable windshield of claim 11, wherein the first bus bar is located proximate an upper edge of the windshield, and the second bus bar is located proximate a lower edge of the windshield.

16. The electrically heatable windshield of claim 13, wherein the conductive profile comprises a respective locally narrow region on a passenger side of the windshield and a respective locally narrow region on a driver side of the windshield.

17. The electrically heatable windshield of claim 11, further comprising a third bus bar and a fourth bus bar ohmically coupled to the at least one current isolated region.

18. The electrically heatable windshield of claim 11, further comprising a third bus bar ohmically coupled to the effective conduction region.

19. A method for manufacturing a heated windshield, comprising:
coating a windshield sheet substrate with a conductive coating to substantially completely cover the windshield;
ohmically coupling the conductive coating between a first bus bar and a second bus bar; and
selectively removing the conductive coating along isolation paths to pattern an effective conduction region and current isolated regions, wherein the effective conduction region comprises a conductive profile with at least one locally narrow region between the first bus bar and the second bus bar.

20. The method of claim 18, wherein selectively removing the conductive coating along isolation paths comprises ablating the conductive coating along isolation paths.
